(19) United States
(12) Patent Application Publication
(10) Pub. No.: US 2022/0377461 A1
(43) Pub. Date: Nov. 24, 2022

(54) AUDIO CONTROL SYSTEM

(71) Applicant: UNIVERSITY OF MARYLAND, COLLEGE PARK, College Park, MD (US)

(72) Inventors: Ramani DURAISWAMI, Highland, MD (US); Shoken Eckhart KANEKO, North Bethesda, MD (US); Nail A. GUMEROV, Elkridge, MD (US); Nirupam ROY, Woodstock, MD (US)

(73) Assignee: UNIVERSITY OF MARYLAND, COLLEGE PARK, College Park, MD (US)

(21) Appl. No.: 17/736,641

(22) Filed: May 4, 2022

Related U.S. Application Data
(60) Provisional application No. 63/184,094, filed on May 4, 2021.

(51) Int. Cl. H04R 5/04; H04R 5/027; H04R 3/04

(52) U.S. Cl. CPC H04R 5/04; H04R 5/027; H04R 3/04

(57) ABSTRACT

An audio control system includes at least one microphone, at least one speaker, and one or more processors. The at least one microphone is at a first position adjacent to an ear of a user and configured to detect a sound field at the first position and output a sound signal indicative of the detected sound field. The at least one speaker is at a second position spaced from the first position and configured to output sound responsive to receiving an audio signal. The one or more processors are configured to generate the audio signal based on the sound signal and a target parameter of the sound field at (i) the first position and (ii) a third position spaced from the first position; and provide the audio signal to the at least one speaker to cause the at least one speaker to output the sound responsive to receiving the audio signal.

The present application claims the benefit of priority to U.S. Provisional Application No. 63/184,094, filed May 4, 2021, the disclosure of which is incorporated herein by reference in its entirety.

### BACKGROUND

The present disclosure relates to audio control. More particularly, the present disclosure relates to audio control systems to perform active control of sound fields.

Audio control systems can be used to control various parameters of sound in various environments. For example, noise cancelling devices, such as headphones, can use physical materials and also output cancellation signals to reduce the amount of undesired sound being received by a user. However, it is difficult to implement audio control in a manner that is flexible with respect to differing environments, such as differing locations of audio output devices as well as scatterers in the environment.

### SUMMARY

Systems and methods in accordance with the present disclosure can enable improved active control of radiated, incident, and/or local personal sound fields. For example, various audio control tasks such as speech privacy, personal active noise cancellation, and immersive audio presentation can be achieved while mitigating amplification or injection of noise or leakage of private speech into the environment. For example, various aspects of a sound field can be pre-computed (e.g., modeled and/or simulated) in a computationally efficient manner to more effectively control the sound field for various such tasks. This can enable audio control in various environments, such as office spaces, public spaces, and vehicles, and allow for audio control using infrastructure in the environment, such as speakers and microphones in the environment.

At least one aspect relates to an audio control system. The audio control system can include at least one microphone, at least one speaker, and one or more processors. The at least one microphone is at a first position adjacent to an ear of a user and configured to detect a sound field at the first position and output a sound signal indicative of the detected sound field. The at least one speaker is at a second position spaced from the first position and configured to output sound responsive to receiving an audio signal. The one or more processors are configured to generate the audio signal based on the sound signal and a target parameter of the sound field at (i) the first position and (ii) a third position spaced from the first position; and provide the audio signal to the at least one speaker to cause the at least one speaker to output the sound responsive to receiving the audio signal.

At least one aspect relates to a method. The method can include receiving, by one or more processors from at least one microphone at a first position adjacent to an ear of a user, a sound signal indicative of a sound field detected at the first position; generating, by the one or more processors, an audio signal based on the sound signal and a target parameter of the sound field at (i) the first position and (ii) a second position; and outputting, by the one or more processors, the audio signal to at least one speaker to cause the at least one speaker to output sound responsive to receiving the audio signal.

At least one aspect relates to an audio control system. The audio control system can include a plurality of microphones, at least one speaker, and one or more processors. The plurality of microphones are at a plurality of first positions spaced from a user and configured to detect a sound field at a respective first position of the plurality of first positions and output a sound signal indicative of the detected sound field. The at least one speaker is at a second position spaced from the first position and configured to output sound responsive to receiving an audio signal. The one or more processors are configured to generate the audio signal based on the sound signal and a target parameter of the sound field at the plurality of first positions and provide the audio signal to the at least one speaker to cause the at least one speaker to output the sound responsive to receiving the audio signal.

At least one aspect relates to a method. The method can include receiving, by one or more processors from a plurality of microphones at a plurality of first positions, a sound signal indicative of a sound field detected at the plurality of first positions; generating, by the one or more processors, an audio signal based on the sound signal and a target parameter of the sound field at the plurality of first positions; and outputting, by the one or more processors, the audio signal to at least one speaker spaced from the plurality of first positions to cause the at least one speaker to output sound responsive to receiving the audio signal.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 depicts a block diagram of an example of an audio control system including one or more wearable components.

FIG. 2 depicts a block diagram of an example of an audio control system.

FIG. 3 depicts a schematic diagram of a model implemented by an audio control system.

FIG. 4 depicts charts of an example of sound fields determined by an audio control system.

FIG. 5 depicts charts of an example of reduction levels implemented by an audio control system.

FIG. 6 depicts charts of an example of cancellation performed by audio control systems.

FIG. 7 depicts charts of an example of sound fields controlled by an audio control system.

FIG. 8 depicts a flow diagram of an example of a method of audio control for personal active noise cancellation.

FIG. 9 depicts a flow diagram of an example of a method of audio control for speech privacy.

### DETAILED DESCRIPTION

The present disclosure provides for many different embodiments. While certain embodiments are described below and shown in the drawings, the present disclosure provides only some examples of the principles described herein and is not intended to limit the invention to the embodiments illustrated and described.

Systems and methods described herein can enable improved active control of radiated, incident, and/or local personal sound fields. For example, various audio control tasks such as speech privacy, personal active noise cancellation, and immersive audio presentation can be achieved while mitigating amplification or injection of noise or leakage of private speech into the environment. For example, various aspects of a sound field can be pre-computed (e.g., modeled and/or simulated) in a computationally efficient manner to more effectively control the sound field for various such tasks. This can enable audio control in various environments, such as office spaces, public spaces, and vehicles, and allow for audio control using infrastructure in the environment, such as speakers and microphones in the environment. For example, distributions of environmental and body worn loudspeakers and microphones can be used to measure, predict, and control the sound field reaching the ears of a user or radiated by the user (e.g., from the user speaking).

Systems and methods in accordance with the present disclosure can enable a flexible framework to achieve active audio control in various environments and use cases, including (i) personal active noise cancellation (ANC); (ii) radiation cancellation for speech privacy; and (iii) immersive audio presentation. For example, cancellation fields can be determined by the audio control system and outputted by one or more speakers to cancel noise (e.g., external sound from the environment) and/or radiation (e.g., sound from a user speaking). Properly generating cancellation fields can be technically challenging due to factors such as (i) the radiation cancellation field can constructively interfere with the radiated field in some locations, which can result in leakage of private speech (e.g., in a coffee shop or airport setting); (ii) the noise cancellation field can constructively interfere with the external field at some locations, which can create extra noise at those locations; and/or (iii) the audio content field (e.g., transaural field) is radiated not only to the user's ears but also to the environment as distracting sound. To address various such factors and improve how the sound fields are controlled, systems and methods in accordance with the present disclosure can implement regularization schemes to control target parameters of the sound fields, such as to avoid or reduce excessive amplitudes of one or both of the cancellation field and audio content field at particular locations.

For example, the audio control system can use a model that accounts for scattering in a variety of applications and environments, such as scattering off the room, off of room and furniture surfaces, and off of the person. This can include, for example, using a model based on solving the Helmoltz equation using a fast multipole accelerated boundary element method (FMMBEM) and using measurements of the sound field from microphones distributed in the environment (including on the user, such as microphones adjacent to one or more ears of the user). To facilitate efficiently determining solutions and generating audio signals (e.g., cancellation field signals and audio content signals) based on the model, communications between the microphones, processors, and speakers can be implemented using network connections, enabling the audio control system to collect and process data in an approximately common clock and taking advantage of the relatively fast communication through the network as compared with the speed of sound.

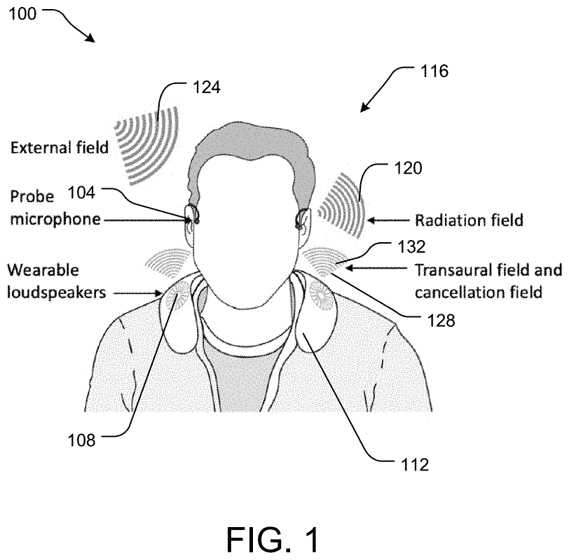

FIG. 1 depicts an example of an audio control system 100. The audio control system 100 includes at least one microphone 104 and at least one speaker 108. The microphones 104 can detect a sound field at the positions of the microphones 104 and output a sound signal corresponding to the detected sound field. As depicted in FIG. 1, the microphones 104 can be wearable, such as by including one or more straps, hooks, fasteners, pads, or other structures to facilitate being worn by a user. For example, the microphones 104 can be shaped to be worn adjacent to ears of the user to enable detecting the sound field adjacent to the ears of the user. The microphones 104 can be provided as part of a room or other structures in an environment, such as by being implemented using microphones in portable or desktop computing devices.

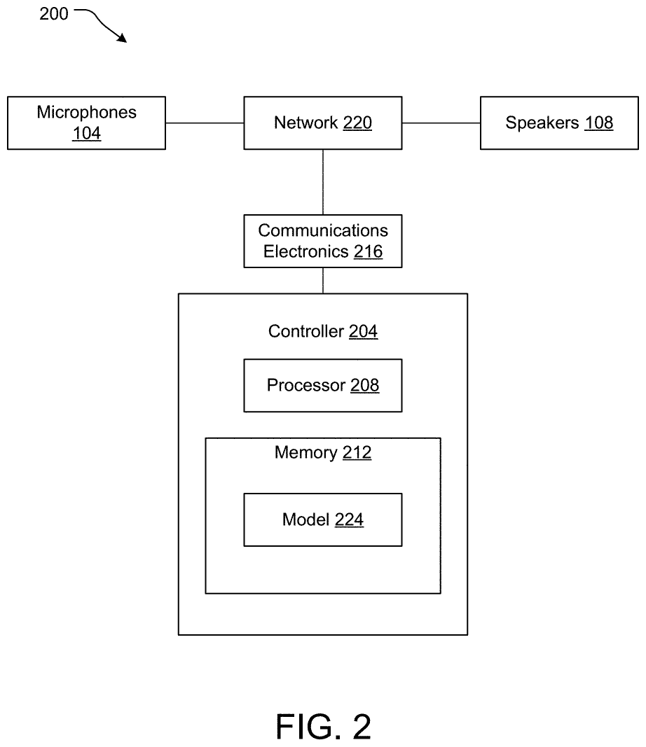

The speakers 108 can receive an audio signal (e.g., from controller 204 described with reference to FIG. 2) and output sound responsive to receiving the audio signal. The speakers 108 can be wearable, as depicted in FIG. 1. For example, the speakers 108 can include one or more straps, hooks, fasteners, pads, or other structures to facilitate being worn by a user. As depicted in FIG. 1, the speakers 108 can be in a wearable housing 112 shaped to be worn around a neck of the user, so that the speakers 108 are oriented towards the ears of the user. The speakers 108 can be implemented using speakers in the environment, such as speakers of portable or desktop computing devices, or speakers coupled with or otherwise built into building structures, such as walls or ceilings.

A sound field 116 (e.g., total sound field) can be present in the environment based on various sound fields (e.g., sound field components). For example, sound fields may be present including a radiation field 120, an external field 124, a cancellation field 128, and an audio content field 132, or various combinations of one or more of such fields. For example, the cancellation field 128 and audio content field 132 (e.g., transaural field) can be a combined sound output from the speakers 108. Each of the fields can include multiple components, such as by being generated by multiple sources; for example, the external field 124 can include multiple sound field components from multiple sound sources in the environment. Due to the speed of sound and thus time for propagation of sound, as well as the presence of scatterers or other structures in the environment affecting how the sound propagates, various sound fields may or may not be present or may vary in amplitude (at any given point in time) at a particular position in the environment relative to other positions in the environment.

The radiation field 120 can be a sound field from the user's speech (e.g., vocal radiation). The external field 124 can be based on ambient noise including radiation from other people speaking in the environment, noise generated by machines, vehicles, HVAC devices, or other devices in the environment, other audio output devices (e.g., speakers) in the environment, or various combinations thereof.

At least one of the cancellation field 128 or the audio content field 132 can be outputted by the speakers 108 responsive to receiving audio signal(s). For example, responsive to receiving the audio signals, the speakers 108 can output sound providing audio content, such as a transaural field for the audio content field 132 to represent the audio content, for reception at the user's ears, as well as the cancellation field 128 to reduce or otherwise mitigate the external field 124 at the positions of the user's ears. As such, one or more target tasks of the audio control system 100, such as personal active noise cancellation (ANC); (ii) radiation cancellation for speech privacy; and (iii) immersive audio presentation, can be achieved using the audio control system 100.

FIG. 2 depicts an example of an audio control system 200. The audio control system 200 can include features of the audio control system 100 described with reference to FIG. 1. For example, the audio control system 200 can include the at least one microphone 104 and the at least one speaker 108.

The audio control system 200 can include a controller 204. The controller 204 can include one or more processors 208 and memory 212. The processor 208 can be implemented as a specific purpose processor, an application specific integrated circuit (ASIC), one or more field programmable gate arrays (FPGAs), a group of processing components, or other suitable electronic processing components. The processors 208 and memory 212 can be implemented using one or more devices, such as devices in a client-server implementation. The memory 212 can include one or more devices (e.g., RAM, ROM, flash memory, hard disk storage) for storing data and computer code for completing and facilitating the various user or client processes, layers, and modules. The memory 212 can be or include volatile memory or non-volatile memory and may include database components, object code components, script components, or any other type of information structure for supporting the various activities and information structures of the inventive concepts disclosed herein. The memory 212 can be communicably connected to the processor 208 and include computer code or instruction modules for executing one or more processes described herein. The memory 212 can include various circuits, software engines, and/or modules that cause the processor 208 to execute the systems and methods described herein, such as to generate audio signals based on models 224 stored by memory 212. Various aspects of or functions performed by the controller 204 can be implemented by one or more of the at least one microphone 104, the at least one speaker 108, one or more computing devices separate from and communicatively coupled with the at least one microphone 104 and the at least one speaker 108, or various combinations thereof.

The controller 204 can include or be coupled with communications electronics 216. The communications electronics 216 can conduct wired and/or wireless communications. For example, the communications electronics 216 can include one or more wired (e.g., Ethernet) or wireless transceivers (e.g., a Wi-Fi transceiver, a Bluetooth transceiver, a NFC transceiver, a cellular transceiver). The at least one microphone 104 and the at least one speaker 108 can also include features of the communications electronics 216.

The audio control system 200 can include or be coupled with a network 220. The network 220 can be one or more wired or wireless communications networks, such as Ethernet, Wi-Fi, Bluetooth, or cellular networks, or various combinations thereof. The controller 204 can communicate with the at least one microphone 104 and the at least one speaker 108 using the network 220. For example, the controller 204 can receive sound signals from the microphones 104 via the network 220, and can transmit audio signals to the speakers 108 via the network 220. Due to the relatively lower limit on communication speed of sound (i.e. limited by the speed of sound) as compared with network communications (i.e. limited by the speed of light and/or network communication speeds), using the network 220 can enable the controller 204 to perform processing and control signal generation operations in real-time or substantially real-time, such as to generate a cancellation signal to cancel an external field based on a sound signal from a particular microphone 104 faster than the time for the external field to propagate from the position of the particular microphone 104 to the user's ears.

Referring further to FIG. 2 and briefly to FIG. 1, the controller 204 can be used to control the sound field 116, such as to control the sound field 116 as received or emitted by the user, who may be a listener, speaker, or both at various points in time. The controller 204 can control the sound field 116 by modeling acoustic transfer functions (TFs) based on modeling of scattering involved in the environment.

For example, the controller 204 can have one or more models 224 that represent the sound field 116 by modeling the TFs. The models 224 can represent the sound field 116 by indicating one or more target parameters of the sound field 116 at one or more positions in the environment. For example, the model 224 can represent the sound field 116 as at least one of an amplitude, a sound pressure, or a frequency at one or more particular positions in the environment. The controller 204 can use the model 224 to represent a system including the user, an arbitrary set of scatterers, a set of Nₛ speakers (e.g., speakers 108) and Nₘ microphones (e.g., microphones 104) which can be worn by the user or distributed in space, Nₜ target listening points, a room enclosing the objects, or various combinations thereof. The positions of the microphones 104 can be probe points. The target listening points can be test points corresponding to the listener's ear positions.

Given a specific geometry and boundary conditions in the system, the controller 204 can evaluate the TFs from sound sources to observation points (e.g., probe points and/or test points) by solving the Helmholtz equation numerically using the FMMBEM.

For example, the controller 204 can represent (e.g., using the model 224) the total sound field (e.g., sound field 116) in the system, p^{(tot)}, using Equation 1:

p^{(tot)}=p^{(rad)}+p^{(ext)}+p^{(can)}+p^{(tra)} (1)

where p^{(ext)} is the ambient sound arriving from the environment (e.g., external field 124), p^{(rad)} is the field generated by the user's vocal radiation (e.g., radiation field 120), p^{(can)} is the field generated by the speakers 108 in order to cancel p^{(ext)} and/or p^{(rad)} (e.g., cancellation field 128), and p^{(tra)} is the sound field generated by the speakers 108 in order to present the immersive audio to the user (e.g., audio content field 132), respectively.

The controller 204 can perform sound field control by generating one or more audio signals to output to the speakers 108 using the model 224. For example, the controller 204 can perform sound field control based on a multi-point pressure-matching scheme or on a band-limited spherical harmonics (SH)-domain mode-matching scheme.

The SH-domain representation can be computed by SH transform defined in Equation 2:

pₙ^{m}=∫_{φ=0}^{2π}∫_{θ=0}^{π}p(r,θ,φ)Yₙ^{m}(θ,φ)*sin θdθdφ, (2)

where p is the sound pressure at point (r, θ, φ) in the spherical coordinates and Yₘⁿ the spherical harmonic of degree n and order m.

The controller 204 can use the model 224 to generate the audio signal to perform various audio control tasks by controlling the speakers 108. For example, the controller 204 can perform personal ANC, such as to perform personal ANC of the external field 124 using the cancellation field 128. The controller 204 can perform personal ANC by controlling the speakers 108 to reduce or minimize an amplitude of a residual field p^{(res)}, where p^{(res)}=p^{(ext)}+p^{(can)} (e.g., the combination of the external field 124 at the cancellation field 128 at the test points corresponding to the positions of the user's ears). The controller 204 can perform personal ANC by controlling the speakers 108 to reduce or minimize a band-limited SH-domain representation of the sound field 116. For example, the controller 204 can receive sound signals from an array of the microphones 104, such as a spherical array around the user or an array worn by the user to represent an arbitrary shaped scatterer and considering the SH representation on a sphere around the user. The controller 204 can model the external field 124 as a stationary field periodic in time, which is a property of a wide range of real world noises generated by machines/HVAC systems.

The controller 204 can perform active radiation cancellation (ARC) of the radiation field 120 generated by the user for privacy. For example, similar to performing ANC, the controller 204 can control the speakers 108 to reduce or minimize an amplitude of the residual field p^{(res)} at particular positions at which privacy is being targeted, such as one or more particular positions remote from the user (e.g., more than 2 feet from the user; more than 5 feet from the user; more than 10 feet from the user; between 2-20 feet from the user; between 5 and 15 feet from the user; on a sphere about 10 feet from the user). The controller 204 can control the speakers 108 based on the SH-domain signal on a sphere around the user.

The controller 204 can perform ARC based on an intelligibility score for the radiation field 120 at one or more particular positions. The intelligibility score can represent an expectation of a listener being able to understand speech represented by the radiation field 120 at the one or more particular positions. The controller 204 can compare the intelligibility score with a target score (e.g., maximum score below which the speech represented by the radiation field 120 is not expected to be understood) and modify the cancellation field 128 responsive to the comparison, such as to modify at least one of a frequency or an amplitude of the cancellation field 128. The controller 204 can determine the intelligibility score based on the sound signals from the microphones 104, such as based on at least one of a frequency or an amplitude of the sound field 116 detected by the microphones 104 (e.g., using a lookup table or other data structure mapping frequency and/or amplitude to intelligibility score, or by providing the sound signal to a speech recognition model and measuring an amount of intelligible speech detected by the speech recognition model).

The controller 204 can control the speakers 108 to facilitate presenting immersive spatial audio to the user, such as by cancelling crosstalk (e.g., performing crosstalk cancellation (XTC)). For example, the controller 204 can control the speakers 108 to produce sound at the user's ears that matches an input binaural signal (e.g., an audio content component of the audio signal provided to the speakers 108). The controller 204 can control the speakers 108 based on a target value of the SH incident field.

Referring further to FIG. 2, the controller 204 can perform various such audio control operations by solving a constrained multi-point pressure-matching problem, an SH mode-matching problem, or combinations thereof, by computing the TFs in space-domain or SH-domain, such as by using FMMBEM. For example, this can enable the controller 204 to represent the tasks being performed as particular filters for particular positions of microphones 104 (e.g., probe points), particular positions of speakers 108, and/or particular positions of the user's ears (e.g., target listening points points), such as to pre-compute filters for ANC, ARC, and/or XTC, and apply the sound signals from the microphones 104 as input to the filters to generate the audio signals to control the speakers 108. This can enable the controller 204 to address various technical challenges such as (i) the radiation cancellation field can constructively interfere with the radiated field in some locations, which can result in leakage of private speech (e.g., in a coffee shop or airport setting); (ii) the noise cancellation field can constructively interfere with the external field at some locations, which can create extra noise at those locations; and/or (iii) the audio content field (e.g., transaural field) is radiated not only to the user's ears but also to the environment as distracting sound.

### Objective Functions and Driving Signals

The formulation of the operations performed by the controller 204 is described below in the frequency domain and arguments denoting frequency are omitted. The controller 204 can represent the cancellation signal as a vector, c_{(can)}=(c̅₁,c₂, . . . ,c_{N}_{ₛ})^{T}ϵ [symbol] ^{N}^{ₛ}^{^{−}} where cᵢ is the frequency dependent complex amplitude representing the signal for the i-th speaker 108.

To perform ARC, the controller 204 can determine a cost function:

L_{λ}^{(ARC)}=∥pₜₑₛₜ^{(rad)}+Hₜₛc^{(can)}∥₂²+λ∥c^{(can)}∥₂² (3)

where pₜₑₛₜ^{(rad)} is the radiation field at the test points, Hₜₛ the Nₜ×Nₛ matrix holding the TFs from the loudspeakers to the test points, and λ>0 a regularization parameter. The controller 204 can determine a driving signal (e.g., optimal driving signal) using a least squares function:

cₒₚₜ^{(can)}=−(Hₜₛ^{H}Hₜₛ+λI)⁻¹Hₜₛ^{H}pₜₑₛₜ^{(rad)} (4)

where pₜₑₛₜ^{(rad)} is computed from the signal captured via a microphone near the mouth and TFs from the mouth to the test points.

To perform ANC, the controller 204 can determine c^{(can)} using a total sound field (e.g., sound field 116) measured at the probe points, p_{probe}^{(tot)}εC^{Nm}. The controller 204 can determine c^{(can)} to reduce or minimize the residual field at the test points, pₜₑₛₜ^{(res)}, and to reduce or minimize an energy score. For example, the controller 204 can determine a cost function L_{λ}^{(ANC)} as a sum of the squared norm of p_{probe}^{(res)} and a regularization term proportional to the energy of the cancellation signal in Equation 5:

L_{λ}^{(ANC)}=∥p_{probe}^{(res)}∥₂²+λ∥c^{(can)}∥₂² (5)

The controller 204 can determine c^{(can)} to minimize the cost L_{λ}^{(ANC)} as:

$$\begin{matrix}{c}_{opt}^{( can )} = - {( {H}_{m s}^{H} {H}_{m s} + λ I )}^{- 1} {H}_{m s}^{H} {p}_{probe}^{( ext )} \\ = {H}^{( can )} {p}_{probe}^{( ext )}\end{matrix} , \qquad ( 6 )$$

where Hₘₛ is a Nₘ×Nₛ matrix holding the TFs from the loudspeakers to the probe points and

$${p}_{probe}^{( ext )} = {p}_{probe}^{( res )} - {H}_{{ms}^{{c}^{( can )}}}$$

is the signal component due to the external field. H^{(can)} ≡−(Hₘₛ^{H}ₘₛ+λI)⁻¹Hₘₛ^{H} can be referred to as the cancellation filter matrix.

To perform XTC, the controller 204 can determine an objective function as:

L_{λ}^{(XTC)}=∥s^{(bin)}−H_{rtf}H_{xtc}s^{(bin)}∥₂²+λ∥H_{xtc}s^{(bin)}∥₂², (7)

with H_{xtc} a Nₛ×2 matrix holding the XTC filters, which is multiplied with the input binaural signal s^{(bin)} for generating p^{(tra)}, and H_{rtf} a 2×Nₛ matrix holding the TFs from the speakers 108 to the listener's ears. The controller 204 can determine the function (e.g., filter) to generate the audio signal as:

H_{xtc}=(H_{rtf}^{H}H_{rtf}+λI)⁻¹H_{rtf}^{H} (8)

To perform various such operations using an SH-domain formulation, the controller 204 can use SH-domain counterparts for the signal vectors and TFs. The controller 204 can use an L₁ norm for regularization to enforce sparsity of speaker 104 activations, but losing the closed form results.

The controller 204 can pre-compute the TFs in accordance with various such operations. For example, the controller 204 can determine the TFs based on sound signals from microphones 104 positioned in various arrangements and environments representative of runtime use environments, and store representations of the TFs to be used at runtime (e.g., in a live environment) for generating the audio signals to output to the speakers 108.

The controller 204 can determine the TFs by performing at least one of motion tracking (e.g., head tracking) or using head-related transfer functions (HRTFs). For example, the controller 204 can apply position data received from one or more positions sensors (e.g., position sensors on the head of the user) as input to one or more HRTF functions to modify the TFs responsive to the position data. The HRTFs can be individualized (e.g., based on image data representative of ears of the user) to personalize the HRTFs for the particular user.

### Regularization Parameter Optimization

The controller 204 can determine the model 224 (e.g., TFs of the model 224) based on target parameters at various positions in the environment, such as based on sound pressure at positions remote from the user. This can facilitate, for example, mitigating constructive interference between the external field 124 and cancellation field 128, and preventing leakage of the radiation field 120 away from the user.

For example, the controller 204 can evaluate sound pressure at an additional set of Nₒ points, the optimization points, pₒₚₜ c C^{No}, to determine (e.g., optimize) the regularization parameter as part of pre-computing the TFs and/or the models 224.

For example, to perform ARC, the controller 204 can determine a reduction level R(p_{Q}) on a set of points Q:

R(p_{Q})=20(log₁₀∥p_{Q}^{(rad)}∥₂−log₁₀∥p_{Q}^{(res)}∥₂) (9)

where p_{Q}^{(ext)} and p_{Q}^{(res)} are vectors holding the sound pressure of the external and the residual field at points Q, respectively. For the optimization of λ, the global cost function is defined in Equation 10:

L^{(glob)}(λ)=−R(pₒₚₜ) (10)

The controller 204 can use the sound pressure at the optimization points pₒₚₜ during generation (e.g., testing, training) of the models 224 and/or TFs, such as for optimizing the hyperparameter λ, and thus may not require receiving sound signals from microphones 104 at the positions pₒₚₜ at runtime. As such, the models 224 and/or TFs can be determined with relatively high fidelity, and then used in less hardware- and/or computationally-demanding environments (e.g., where fewer microphones 104 are available) at runtime while still providing appropriate audio control. Similar global cost functions can be designed for ANC and XTC. For example, the controller 204 can use p_{Q}^{(rad)} instead of p_{Q}^{(ext)} for a global cost function for ANC.

### Example Implementations

Various examples and results, including from numerical simulations, are described herein based on wearable neckband speakers 108, such as speakers 108 closely located to the user's ears, such as to evaluate the use of two to seven speakers 108 by simulation.

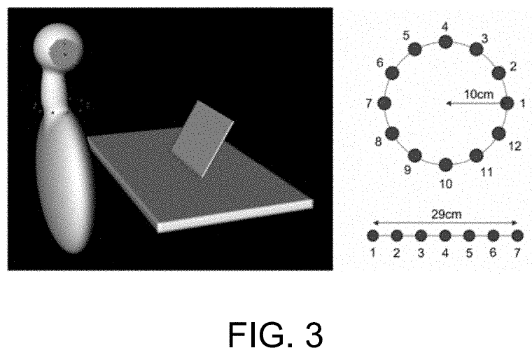

The neckband and laptop arrays are simulated. To include scattering from the head, neck, torso, laptop screen, and desk, a simplified mesh was used for the FMMBEM simulation of the TFs, as shown in FIG. 3 (left). A Robin boundary condition with specific admittance of 5.3×10⁻² was used for all boundaries. The loudspeakers were modelled as monopole sources for the purpose of this exercise, though more complex radiation patterns can be simulated. Their positions are indicated with red dots in FIG. 3 (left). Twelve equispaced points on the circle of radius 10 cm were defined as the neckband loudspeaker positions. The laptop loudspeakers were located on seven equispaced points on a line segment with a length of 29 cm. Arrays consisting of two or seven loudspeakers were used in the experiments, by choosing a subset. The channels used in each configuration are shown in FIG. 3 (right) and Table 1, respectively. The BEM simulation of the TFs in the given system took around 30 seconds for each sound source at 500 Hz using a laptop.

TABLE 1
Loudspeaker channels used in each configuration

| # Loudspeakers | Neckband | Laptop |
|---|---|---|
| 2 | {1, 7} | {1, 7} |
| 7 | {1, 3, 5, 7, 9, 10, 11} | {1, 2, 3, 4, 5, 6, 7} |

### ARC

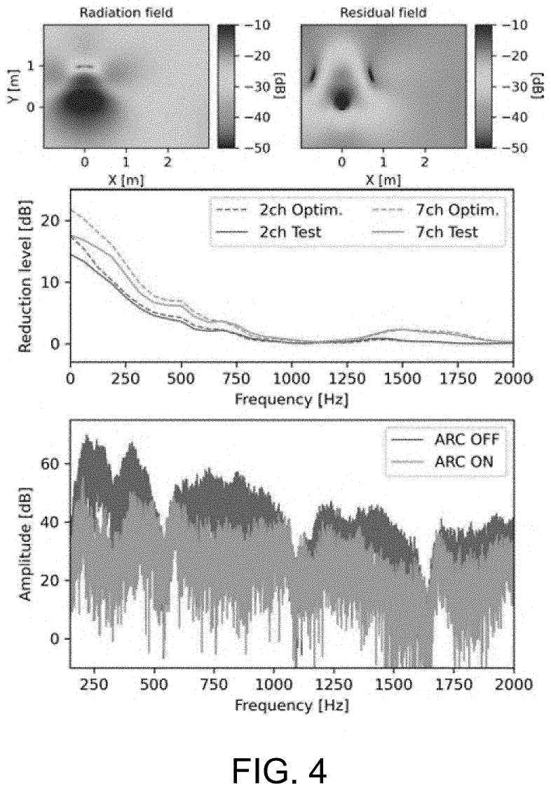

The ARC task (i) was simulated for the neckband system. The vocal radiation was approximated by a monopole source located at the mouth. The test and optimization points were 2048 spherical Fibonacci grid points on spheres of radii 0.5 m and 0.7 m centered at the origin. The fields before and after cancellation for the 7ch system are shown in FIG. 4 (top). The reduction level for the 2ch and 7ch arrays are shown in FIG. 4 (middle). The ARC simulation was also conducted using IRs measured in a real anechoic room. A 48-channel planar microphone array (VisiSonics Digital Array Microphones) forming a 8×6 mesh grid of size 35 cm×25 cm was used for measuring the IRs from a source loudspeaker (YAMAHA VXS1MLB) and a cancellation stereo neckband loudspeaker (SONY SRS-WS1). The IR measurement points at d=76 cm and d=96 cm were used as the optimization points and test points, respectively, with d the distance from the source loudspeaker to the microphone array plane. The ARC filters were designed as time domain FIR filters and were convolved with a female human speech source signal to create the cancellation signal. The amplitudes at the microphone positions were then computed by convolving the source and cancellation signals with the measured IRs from source and cancellation loudspeakers, respectively. The amplitude before and after ARC at a single test point is shown in FIG. 4 (bottom). A reduction of up to 20 dB can be observed at frequencies below 1000 Hz.

### ANC

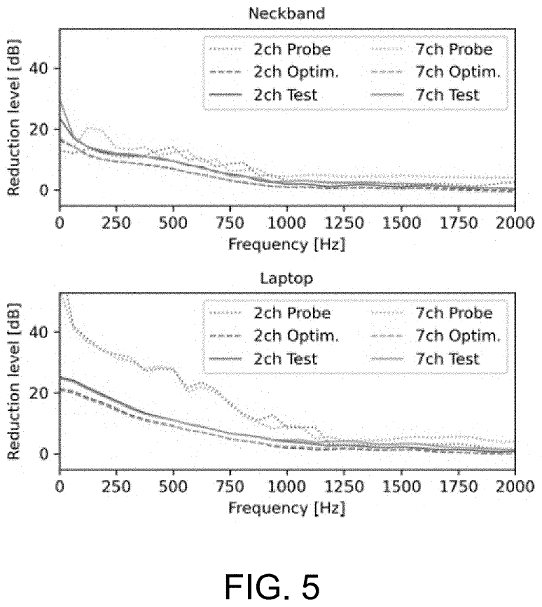

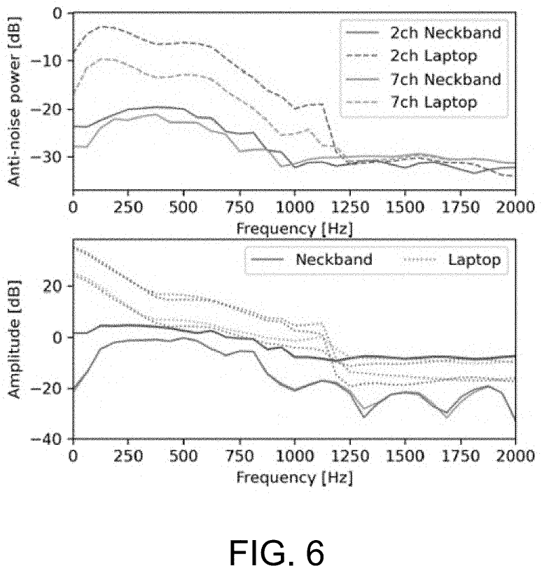

A monopole monochromatic noise source generating a signal with amplitude −22 dB at 1 m distance was placed at point rₙₒᵢₛₑ=(2 m, 1 m, 0) in Cartesian coordinates where the origin is the center of sphere approximating the listener's head and the x- and y-axes are pointing to the right and to the front from the origin. The test points corresponding to the entrance of the ear canals were placed 1 cm from the surface of the sphere with a radius of 9 cm approximating the head of the listener. The microphones, i.e. probe points are placed in the vicinity of the test points approximating the microphones installed in a smart glass or headset device. The distance between the test points and the nearest probe points was 38 mm and 37 mm for the left and right sides, respectively. The set of optimization points consists of Nₒ=271 points in the vicinity of the assumed ear position including the probe points and test points and is indicated as the cyan dots in FIG. 3 (left). A subset of a spherical Fibonacci grid inside of a cone with solid angle 0.842 for both the left and right direction were used as the optimization points. The regularization parameter λ minimizing L^{(glob)}(λ) was sought by grid search on a logarithmic grid in [10⁻¹⁵, 1]. The reduction level on the probe points, optimization points, and test points was computed using the simulated TFs and is shown in FIG. 5 for four different loudspeaker configurations. The reduction level R(pₜₑₛₜ) at the test points at 500 Hz is about 10 dB and 11 dB for the neckband and laptop case, respectively. The increased number of loudspeakers did not improve R(pₜₑₛₜ) in the current setup which has only two probe points. The total power of the cancellation signal defined as p_{c}=20 log₁₀∥c^{(can)}∥₂ is shown in FIG. 5 (top). The power of the cancellation signal produced by the neckband is considerably lower than the laptop array in the lower frequencies where the ANC is effective, with a difference of about 14 dB at 500 Hz in the stereo loudspeaker case. Increasing the number of loudspeakers helps reduce the total power of the cancellation signal. FIG. 6 (bottom) shows the cancellation filters for the stereo loudspeaker setups. A significant boost in amplitude can be observed at low frequencies for the laptop setup—a common phenomenon in XTC systems using frontal loudspeakers with small spacing relative to the wavelength. This low frequency boost is avoided in the neckband setup.

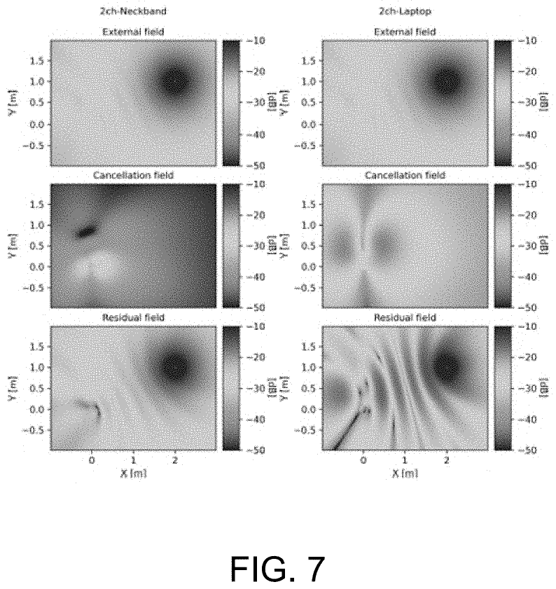

FIG. 7 illustrates the sound fields in the horizontal plane at the height of the listener's head. The external, cancellation, and the residual fields for the example problem with a single monopole monochromatic noise source of 500 Hz are shown. Both the neckband and laptop systems are seen to create silence zones in the vicinity of the test points. The laptop system needs to inject more anti-noise to do so, which results in the creation of additional noisy zones, as seen in the residual field. Audio examples of the PASCAL simulations are available online.

In accordance with various such examples, a framework for personal active sound field control aiming at tasks including personal ANC, speech privacy, and immersive audio can be achieved using the audio control systems 100, 200.

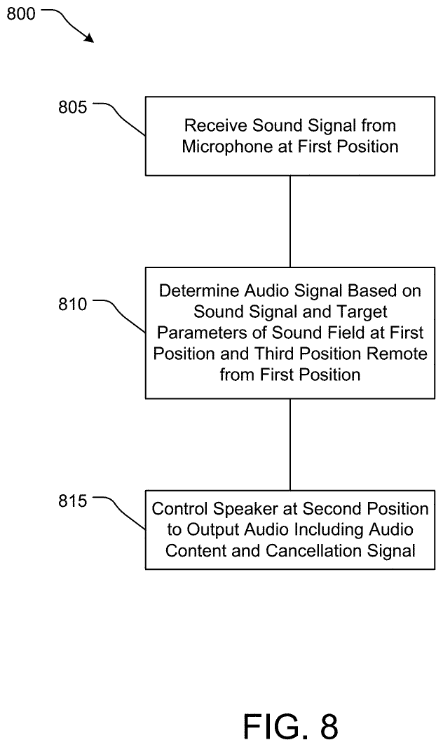

FIG. 8 depicts an example of a method 800 of audio control. The method 800 can be performed using various systems and devices described herein, such as the audio control systems 100, 200. The method 800 can be performed in a runtime context, such as to perform personal active noise cancellation to allow a user to effectively experience noise cancellation (e.g., cancellation of external sound fields) while mitigating or avoid constructive interference resulting from the cancellation at various points around the user. The method 800 can be performed in a dynamic manner, such as by updating the generated audio signals responsive to a change in audio content, a user's position or head tracking, a request to modify the generation of the audio signals, or various combinations thereof. The method 800 can be performed responsive to receiving instructions to perform the audio control, such as by receiving a request to enter a personal activate noise cancellation mode (e.g., responsive to a selection of the mode from a plurality of modes).

At 805, a sound signal indicative of a sound field detected at a first position is received from at least one microphone at the first position. The microphone can be a wearable microphone, such as to position the microphone so that the first positions are adjacent to (e.g., within a threshold distance, such as a distance on the order of inches) from the ears of the user. The sound signal can be received by one or more processors of a controller of an audio control system. The sound signal can be received via a network, which can facilitate more rapid processing of the sound signals.

At 810, an audio signal is generated based on the sound signal, such as to include audio content to be provided to the user as well as a cancellation component to cancel an external field as would otherwise be received at the user's ears. The audio signal can be generated to control operation of one or more speakers at one or more second positions. The audio signal can be generated by applying the sound signal as input to a model, such as an audio transfer function. The model can represent target parameters of a sound field, such as amplitude, sound pressure, frequency, and/or phase, at particular positions responsive to the sound signal. The model can include or be associated with a multi-point pressure matching function or a spherical harmonic function. The model can be pre-computed, such as by generating (e.g., training, calibrating) the model using sound signals from a relatively large number of microphones at third positions, and then operated at runtime using fewer microphones (e.g., no microphones at third positions).

For example, the audio signal can be generated based on the sound signal and target parameters of the sound field at the first position(s) (e.g., the positions of the microphones) and a third position spaced from the first position. The third position can be remote from the first position. For example, the third position can be further from the first position than the second positions of the speakers, such as to represent positions in the environment where constructive interference would otherwise occur between the external field and cancellation component (e.g., cancellation field).

At 815, the audio signal is outputted to the at least one speaker. The audio signal can be outputted via the network. The audio signal can be to cause the speakers to output the cancellation signal, as well as the audio content (e.g., transaural audio). By providing the audio signal based on target parameters at the third position(s), the speakers can output sound that can effectively cancel external noise of the sound field while reducing or avoiding generation of distractive noise away from the user.

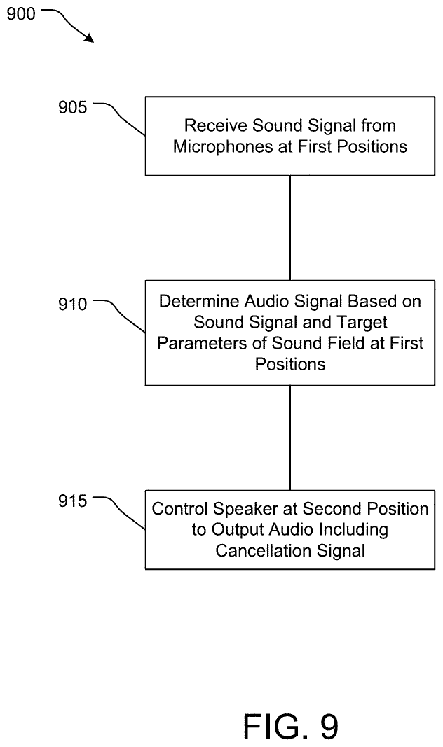

FIG. 9 depicts an example of a method 900 of audio control. The method 900 can be performed in a manner similar to the method 900, and can be performed for personal speech privacy, such as to reduce or avoid leakage of a user's speech at positions away from the user. The method 900 is described in terms of microphones placed away from the user; the method 900 can also be performed using one or more microphones close to the user (e.g., using microphones worn by the user or of a portable electronic device of the user) and using transfer functions generated to represent sound fields away from the user at positions where privacy is desired.

At 905, sound signals indicative of a sound field detected at a plurality of first positions is received from a plurality of microphones at the first positions. The microphones can be at positions at which cancellation of a user's speech is desired. The sound signals can be received by one or more processors of a controller of an audio control system. The sound signal can be received via a network, which can facilitate more rapid processing of the sound signals.

At 810, an audio signal is generated based on the sound signal, such as to generate a cancellation signal to cancel the user's vocal radiation. The audio signal can be generated to control operation of one or more speakers at one or more second positions. The audio signal can be generated by applying the sound signal as input to a model, such as an audio transfer function. The model can represent target parameters of a sound field, such as amplitude, sound pressure, frequency, and/or phase, at particular positions responsive to the sound signal. The model can include or be associated with a multi-point pressure matching function or a spherical harmonic function. The model can be pre-computed, such as by generating (e.g., training, calibrating) the model using sound signals from a relatively large number of microphones at the first positions, and then operated at runtime using fewer microphones.

For example, the audio signal can be generated based on the sound signal and target parameters of the sound field at the first positions. This can enable the audio signal to be generated to cancel the user's vocal radiation at the first positions. The audio signal can be generated based on determining an intelligibility score of the user's vocal radiation, such as to control the cancellation signal (e.g., amplitude, frequency, phase of the cancellation signal) until the intelligibility score is less than a target intelligibility score.

At 815, the audio signal is outputted to the at least one speaker. The audio signal can be outputted to cause the speakers to output the cancellation signal, as well as audio content (e.g., transaural audio) that may be desired to be outputted (e.g., if the user is in a conversation). By providing the audio signal based on target parameters at the first positions, the speakers can output sound that can effectively cancel external noise of the vocal radiation field away from the user.

All or part of the processes described herein and their various modifications (hereinafter referred to as “the processes”) can be implemented, at least in part, via a computer program product, i.e., a computer program tangibly embodied in one or more tangible, physical hardware storage devices that are computer and/or machine-readable storage devices for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer (including a server) include one or more processors for executing instructions and one or more storage area devices for storing instructions and data. Generally, a computer will also include, or be operatively coupled to receive data from, or transfer data to, or both, one or more machine-readable storage media, such as mass storage devices for storing data, e.g., magnetic, magneto-optical disks, or optical disks.

Computer program products are stored in a tangible form on non-transitory computer readable media and non-transitory physical hardware storage devices that are suitable for embodying computer program instructions and data. These include all forms of non-volatile storage, including by way of example, semiconductor storage area devices, e.g., EPROM, EEPROM, and flash storage area devices; magnetic disks, e.g., internal hard disks or removable disks; magneto-optical disks; and CD-ROM and DVD-ROM disks and volatile computer memory, e.g., RAM such as static and dynamic RAM, as well as erasable memory, e.g., flash memory and other non-transitory devices.

The construction and arrangement of the systems and methods as shown in the various embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced. Other substitutions, modifications, changes, and omissions may be made in the design, operating conditions and arrangement of embodiments without departing from the scope of the present disclosure.

As utilized herein, the terms “approximately,” “about,” “substantially”, and similar terms are intended to include any given ranges or numbers +/−10%. These terms include insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. An audio control system, comprising:
at least one microphone at a first position adjacent to an ear of a user, the at least one microphone configured to detect a sound field at the first position and output a sound signal indicative of the detected sound field;
at least one speaker at a second position spaced from the first position, the at least one speaker configured to output sound responsive to receiving an audio signal; and
one or more processors configured to:
generate the audio signal based on the sound signal and a target parameter of the sound field at (i) the first position and (ii) a third position spaced from the first position; and
provide the audio signal to the at least one speaker to cause the at least one speaker to output the sound responsive to receiving the audio signal.

2. The audio control system of claim 1, wherein the target parameter of the sound field at the third position is associated with at least one of an amplitude of the sound field at the third position or a frequency of the sound field at the third position.

3. The audio control system of claim 1, wherein the one or more processors are configured to generate the audio signal by applying the sound signal as input to a function, the function defining the target parameter of the sound field at the first position and at the third position.

4. The audio control system of claim 3, wherein the function is associated with a multi-point pressure matching function or a spherical harmonic function.

5. The audio control system of claim 1, wherein a distance between the third position and the first position is greater than a distance between the second position and the first position.

6. The audio control system of claim 1, wherein the one or more processors are configured to generate the audio signal to include an audio content component associated with audio content to provide to the user of the at least one speaker and a cancellation component associated with the target parameter of the sound field at the first position.

7. The audio control system of claim 1, wherein the at least one speaker is wearable.

8. The audio control system of claim 1, wherein the one or more processors are configured to receive the sound signal from the at least one microphone via a network.

9. A method, comprising:
receiving, by one or more processors from at least one microphone at a first position adjacent to an ear of a user, a sound signal indicative of a sound field detected at the first position;
generating, by the one or more processors, an audio signal based on the sound signal and a target parameter of the sound field at (i) the first position and (ii) a second position; and
outputting, by the one or more processors, the audio signal to at least one speaker to cause the at least one speaker to output sound responsive to receiving the audio signal.

10. The method of claim 9, comprising:
receiving the sound signal from the at least one microphone via a network; and
generating the audio signal, by the one or more processors, to include an audio content component associated with audio content to provide to the user and a cancellation component associated with the target parameter of the sound field at the first position.

11. An audio control system, comprising:
a plurality of microphones at a plurality of first positions spaced from a user, the plurality of microphones configured to detect a sound field at a respective first position of the plurality of first positions and output a sound signal indicative of the detected sound field;
at least one speaker at a second position spaced from the first position, the at least one speaker configured to output sound responsive to receiving an audio signal; and
one or more processors configured to:
generate the audio signal based on the sound signal and a target parameter of the sound field at the plurality of first positions; and
provide the audio signal to the at least one speaker to cause the at least one speaker to output the sound responsive to receiving the audio signal.

12. The audio control system of claim 11, wherein the target parameter of the sound field at the plurality of first positions is an amplitude.

13. The audio control system of claim 11, wherein the one or more processors are configured to generate the audio signal by applying the sound signal as input to a function, the function defining the target parameter of the sound field at the plurality of first positions.

14. The audio control system of claim 13, wherein the function is associated with a multi-point pressure matching function or a spherical harmonic function.

15. The audio control system of claim 11, wherein the one or more processors determine the target parameter based on an expected intelligibility score of the sound field at the plurality of first positions.

16. The audio control system of claim 11, wherein the one or more processors are configured to generate the audio signal to include a cancellation component associated with the target parameter of the sound field at the plurality of first positions based on vocal radiation of the user.

17. The audio control system of claim 11, wherein the at least one speaker is wearable.

18. The audio control system of claim 11, wherein the one or more processors are configured to receive the sound signal from the plurality of microphones via a network.

19. A method, comprising:
receiving, by one or more processors from a plurality of microphones at a plurality of first positions, a sound signal indicative of a sound field detected at the plurality of first positions;
generating, by the one or more processors, an audio signal based on the sound signal and a target parameter of the sound field at the plurality of first positions; and
outputting, by the one or more processors, the audio signal to at least one speaker spaced from the plurality of first positions to cause the at least one speaker to output sound responsive to receiving the audio signal.

20. The method of claim 19, comprising:
receiving the sound signal from the plurality of microphones via a network; and
generating the audio signal, by the one or more processors, to include a cancellation component associated with the target parameter of the sound field at the plurality of first positions based on vocal radiation of the user.
